(19) United States
(12) Patent Application Publication
(10) Pub. No.: US 2010/0167165 A1
(43) Pub. Date: Jul. 1, 2010

(54) COPOLYMER, POLYMER ELECTROLYTE, AND USE THEREOF

(75) Inventors: Kentaro Masui, Ibaraki (JP); Hiroyuki Kurita, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY , LIMITED, Chuo-ku ,Tokyo (JP)

(21) Appl. No.: 12/097,571

(22) PCT Filed: Dec. 19, 2006
(86) PCT No.: PCT/JP2006/025700

§ 371 Date: Jun. 27, 2008

(30) Foreign Application Priority Data
Dec. 20, 2005 (JP) 2005-366013

(51) Int. Cl. H01M 8/10; B01J 47/00; B01J 37/30

(52) U.S. Cl. 429/492; 521/25; 521/27; 502/11

(57) ABSTRACT

The present invention is a copolymer obtained by condensation, a condensation reaction of a leaving group and a nucleophilic group, of a mixture of the following (A) and (C) with a mixture of (B) and (D), or of a mixture of (A), (B), (C) and (D):
(A) a monomer having two leaving groups and further at least one acid group in a molecule;
(B) a monomer having two nucleophilic groups and further at least one acid group in a molecule;
(C) a monomer having two leaving groups and substantially no acid group in a molecule; and
(D) a monomer having two nucleophilic groups and substantially no acid group in a molecule.

### TECHNICAL FIELD

The invention relates to a copolymer preferably used for materials of separating membrane for batteries, particularly fuel cells, to a polymer electrolyte and use thereof.

### BACKGROUND ART

As separating membranes for electrochemical devices such as primary batteries, secondary batteries, or solid polymer fuel cells, polymer electrolytes having proton conductivity are employed. For example, when polymer electrolytes containing perfluoroalkane based polymers having perfluoroalkylsulfonic acid groups as a superacid in the side chains, e.g., Nafion (registered trade name; from Du Pont (E.I) de Nemours & Co.), as an effective component are used as materials of separating membrane for fuel cells, such polymer electrolytes are excellent in properties of power generation and therefore are mainly used at the present. However, such problems have been pointed out that they are very expensive and inferior in heat resistance and that those membranes has low strength for using practically unless being somehow reinforced.

At the present situation, developments of polymer electrolytes economical and excellent in properties and usable in place of the above-mentioned polymer electrolytes have been made actively in recent years.

For example, block copolymers having a segment into which substantially no sulfonic acid group is introduced and a segment into which a sulfonic acid group is introduced, wherein the former segment comprises a polyether sulfone and the latter segment is a condensate of a diphenylsulfone and a biphenol having sulfonic acid group are proposed (Japanese Unexamined Patent Publication No. 2003-031232).

On the other hand, in place of the above-mentioned block copolymers, so-called random copolymers having an acid group distributed randomly along polymer chains has been also investigated and random copolymers of one kind monomer into which a sulfonic acid group is introduced and a monomer into which no sulfonic acid group is introduced have been proposed (see e.g., Japanese Unexamined Patent Publication Nos. 2004-509224 and 2006-523258, U.S. Patent Publication No. 2002/0091225, and Japanese Unexamined Patent Publication No. 2004-149779), or random copolymers obtained by sulfonation of polyether sulfone copolymers (see e.g., Japanese Unexamined Patent Publication No. 10-021943) have been proposed.

### DISCLOSURE OF THE INVENTION

With respect to the block copolymers disclosed in Japanese Unexamined Patent Publication No. 2003-031232, it was required to previously synthesize either one of the segment into which substantially no sulfonic acid group is introduced or the segment into which a sulfonic acid group is introduced and thereafter carry out copolymerization with a monomer capable of forming the other segment, or separately synthesize polymers capable of forming the above-mentioned segments and thereafter further carry out coupling both polymers.

On the other hand, with respect to the random copolymers disclosed in Japanese Unexamined Patent Publication Nos. 2004-509224 and 2006-523258, U.S. Patent Publication No. 2002/0091225, Japanese Unexamined Patent Publication No. 2004-149779, and Japanese Unexamined Patent Publication No. 10-021943, as compared with the above-mentioned block copolymers, their synthesis itself is relatively easy, however, when it is tried to obtain practically useful proton conductivity for materials of separating membrane for batteries, the water absorbability of the random copolymers is increased and separating membranes to be obtained have problems that their sizes are significantly changed due to the water produced at the time of operating fuel cell and consequently mechanical strength is decreased. Particularly, according to the results of the investigations the inventors of the present invention have carried out, polymer electrolytes containing the random copolymers which have been disclosed previously have considerably high water absorbability of hot water at about 100° C. and therefore, when they are used for separating membranes (polymer electrolyte membranes) of fuel cells, the polymer electrolyte membranes themselves tend to be deformed by water absorption due to heat generated by power generation.

The inventors of the present invention have investigated repeatedly to solve the above-mentioned problems and consequently, they have now completed the present invention.

That is, the invention provides a copolymer obtained by nucleophilic condensation of a mixture of (A) and (C) with a mixture of (B) and (D), or of a mixture of (A), (B), (C) and (D) as follows:

(A) a monomer having two leaving groups and further at least one acid group in a molecule;
(B) a monomer having two nucleophilic groups and further at least one acid group in a molecule;
(C) a monomer having two leaving groups and substantially no acid group in a molecule; and
(D) a monomer having two nucleophilic groups and substantially no acid group in a molecule.

Herein, the nucleophilic groups means groups having nucleophilicity, causing nucleophilic attack to atoms to which the leaving groups are bonded and being thus capable of forming new covalent bonds by condensation reaction which is accompanied with elimination of the leaving groups. The nucleophilic groups in the present invention differ from acid groups described below and have higher nucleophilicity than that of the acid groups.

Since monomers having the nucleophilic groups and leaving groups are different, the monomers having the nucleophilic groups cause condensation reaction only with the monomers having the leaving groups and form covalent bonds. In the copolymers of the present invention, a structural unit (A′) derived from the above-mentioned (A) is adjacent to a structural unit (B′) derived from the above-mentioned (B) or a structural unit (D′) derived from the above-mentioned (D): similarly the structural unit (B′) is adjacent to the structural unit (A′) or a structural unit (C′) derived from the above-mentioned (C): also the structural unit (C′) is adjacent to the structural unit (B′) or the structural unit (D′): and the structural unit (D′) is adjacent to the structural unit (A′) or the structural unit (C′).

Further, the present invention provides a copolymer represented by the following [2] to [8].

[2] The copolymer according to the above-mentioned [1], in which the above-mentioned (A) is represented by the following formula (1):

X¹—Ar¹Z¹—Ar²ₖX¹ (1)

wherein, k denotes 0, 1, or 2; Ar¹ and Ar² each independently denote a divalent aromatic group; when k is 2, two Ar² groups may be the same or different with each other and these divalent aromatic groups may be substituted with an alkyl group having 1 to 10 carbon atoms which may have a substituent, an alkoxy group having 1 to 10 carbon atoms which may have a substituent, an aryl group having 6 to 10 carbon atoms which may have a substituent, an aryloxy group having 6 to 10 carbon atoms which may have a substituent, a fluoro group, a nitro group, or a benzoyl group; when k is 0, Ar¹ has at least one acid group, and when k is 1 or more, at least one of Ar¹ and Ar² has at least one acid group; X¹ denotes one of a fluoro group, a chloro group, a nitro group, or a trifluoromethanesulfonyloxy group; two X¹ groups may be the same or different with each other; Z¹ denotes a group selected from the following groups; and when k is 2, two Z¹ groups may be the same or different with each other:

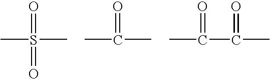

[3] The copolymer according to the above-mentioned [1] or [2], wherein the above-mentioned (B) is represented by the following formula (2):

Y¹—Ar³Q¹-Ar⁴ⱼY¹ (2)

wherein, j denotes 0, 1, or 2; Ar³ and Ar⁴ each independently denote a divalent aromatic group; when j is 2, two Ar⁴ groups may be the same or different with each other and these divalent aromatic groups may be substituted with an alkyl group having 1 to 10 carbon atoms which may have a substituent, an alkoxy group having 1 to 10 carbon atoms which may have a substituent, an aryl group having 6 to 10 carbon atoms which may have a substituent, or an aryloxy group having 6 to 10 carbon atoms which may have a substituent; when j is 0, Ar³ has at least one acid group, and when j is 1 or more, at least one of Ar³ and Ar⁴ has at least one acid group; Y¹ denotes a hydroxyl group, a thiol group, or an amino group; two Y¹ groups may be the same or different with each other; Q¹ denotes a direct bond or a group selected from the following groups; and when j is 2, two Q¹ groups may be the same or different with each other:

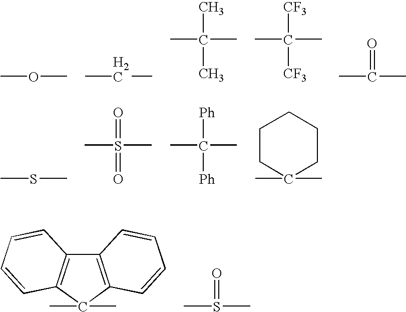

[4] The copolymer according to the above-mentioned [1] to [3], wherein the above-mentioned (C) is represented by the following formula (3)

X²—Ar⁵Z²—Ar⁶ₘX² (3)

wherein, m denotes 0, 1, or 2; Ar⁵ and Ar⁶ each independently denote a divalent aromatic group; when m is 2, two Ar⁶ groups may be the same or different with each other and these divalent aromatic groups may be substituted with an alkyl group having 1 to 10 carbon atoms which may have a substituent, an alkoxy group having 1 to 10 carbon atoms which may have a substituent, an aryl group having 6 to 10 carbon atoms which may have a substituent, an aryloxy group having 6 to 10 carbon atoms which may have a substituent, a fluoro group, a nitro group, or a benzoyl group; X² denotes a fluoro group, a chloro group, a nitro group, or a trifluoromethanesulfonyloxy group; two X² groups may be the same or different with each other; Z² denotes a group selected from the following groups; and when m is 2, two Z² groups may be the same or different with each other:

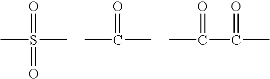

[5] The copolymer according to the above-mentioned [1] to [4], wherein the above-mentioned (D) is represented by the following formula (4)

Y²—Ar⁷Q²-Ar⁸ₙY² (4)

wherein, n denotes 0, 1, or 2; Ar⁷ and Ar⁸ each independently denote a divalent aromatic group; when n is 2, two Ar⁸ groups may be the same or different with each other and these divalent aromatic groups may be substituted with an alkyl group having 1 to 10 carbon atoms which may have a substituent, an alkoxy group having 1 to 10 carbon atoms which may have a substituent, an aryl group having 6 to 10 carbon atoms which may have a substituent, or an aryloxy group having 6 to 10 carbon atoms which may have a substituent; Y² denotes a hydroxyl group, a thiol group, or an amino group; two Y² groups may be the same or different with each other; Q² denotes a direct bond or a group selected from the following groups; and when n is 2, two Q² groups may be the same or different with each other:

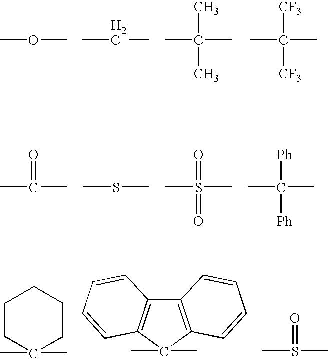

[6] The copolymer according to the above-mentioned [1] to [5], wherein the acid group is a strong acid group or a superacid group.
[7] The copolymer according to the above-mentioned [1] to [6] having an ion exchange capacity of 0.1 meq/g to 4.0 meq/g.
[8] The copolymer according to the above-mentioned [1] to [7], wherein the weight composition ratio of the structural unit into which the acid group is introduced and the structural unit into which substantially no acid group is introduced, [structural unit into which the acid group is introduced]:[structural unit into which substantially no acid group is introduced], is 3:97 to 70:30.

In addition, the invention also provides the following.

[9] A polymer electrolyte containing the copolymer according to any one of the [1] to [8].
[10] A polymer electrolyte membrane containing the polymer electrolyte according to the [9].
[11] A polymer electrolyte composite membrane comprising the polymer electrolyte according to the [9] and a porous substrate.
[12] A polymer electrolyte composite membrane obtained by impregnating a porous substrate with the polymer electrolyte according to the [9], and compositing those.
[13] A catalyst composition comprising the polymer electrolyte according to the [9] and a catalyst material.
[14] A fuel cell using the polymer electrolyte membrane according to the [10].
[15] A fuel cell using the polymer electrolyte composite membrane according to the [11] or [12].
[16] A fuel cell having a catalyst layer comprising the catalyst composition according to the [13].

Further, the present invention provides

[17] A method of producing a copolymer, wherein a mixture of (A) and (C) with a mixture of (B) and (D) is condensed, or a mixture of (A), (B), (C) and (D) is condensed as follows:
(A) a monomer having two leaving groups and further at least one acid group in a molecule;
(B) a monomer having two nucleophilic groups and further at least one acid group in a molecule;
(C) a monomer having two leaving groups and substantially no acid group in a molecule; and
(D) a monomer having two nucleophilic groups and substantially no acid group in a molecule.

### BEST MODES FOR CARRYING OUT THE INVENTION

Hereinafter, preferable embodiments of the present invention will be described.

A copolymer of the present invention can be obtained by mixing and condensing, as indispensable monomers, a mixture of two kind specified monomers having acid groups (the above-mentioned (A) and (B)) with a mixture of two kind specified monomers substantially having no acid group (the above-mentioned (C) and (D)). One or more kinds of monomers (A), (B), (C), and (D) may be used respectively.

The above-mentioned (A) is preferably a compound represented by the above-mentioned formula (1). Herein, the acid groups are characterized in that when k is 0, Ar¹ has the acid groups, and when k is 1 or more, at least one of Ar¹ and Ar² has the acid groups. Ar¹ and Ar² denote a divalent aromatic group and examples of the divalent aromatic group may be hydrocarbon based aromatic groups such as a phenylene group, a naphthylene group, a biphenylylene group, and a fluorenediyl group and heterocyclic groups such as a pyridinediyl group, a quinoxalinediyl group and a thiophenediyl group and among them, divalent hydrocarbon based aromatic groups are preferable and a phenylene group and a naphthylene group are particularly preferable. When k is 1, Ar¹ and Ar² may be the same or different and when k is 2, Ar¹ and two Ar² groups may be the same or different.

Herein, the above-mentioned divalent aromatic groups may be substituted with an alkyl group having 1 to 10 carbon atoms which may have a substituent, an alkoxy group having 1 to 10 carbon atoms which may have a substituent, an aryl group having 6 to 10 carbon atoms which may have a substituent, an aryloxy group having 6 to 10 carbon atoms which may have a substituent, a nitro group and a benzoyl group and examples of the alkyl group having 1 to 10 carbon atoms may include such as a methyl group, an ethyl group, an n-propyl group, an isopropyl group, an allyl group, an n-butyl group, a sec-butyl group, a tert-butyl group, an isobutyl group, an n-pentyl group, 2,2-dimethylpropyl group, a cyclopentyl group, an n-hexyl group, a cyclohexyl group, 2-methylpentyl group and 2-ethylhexyl group and these groups may have halogen atoms such as fluorine atom, chlorine atom, bromine atom or iodine atom, a hydroxyl group, an amino group, a methoxy group, an ethoxy group, an isopropyloxy group, a phenyl group, a naphthyl group, a phenoxy group, and a naphthyloxy group as a substituent.

Examples of the alkoxy group having 1 to 10 carbon atoms may include a methoxy group, an ethoxy group, an n-propyloxy group, an isopropyloxy group, an n-butyloxy group, a sec-butyloxy group, a tert-butyloxy group, an isobutyloxy group, an n-pentyloxy group, 2,2-dimethylpropyloxy group, a cyclopentyloxy group, an n-hexyloxy group, a cyclohexyloxy group, 2-methylpentyloxy group and 2-ethylhexyloxy group and these groups may have substituents selected from a halogen atom, a hydroxyl group, an amino group, a methoxy group, an ethoxy group, an isopropyloxy group, a phenyl group, a naphthyl group, a phenoxy group, and a naphthyloxy group as a substituent.

Examples of the aryl group having 6 to 10 carbon atoms may include a phenyl group and a naphthyl group and these groups may have substituents selected from halogen atoms, a hydroxyl group, an amino group, a methoxy group, an ethoxy group, an isopropyloxy group, a phenyl group, an naphthyl group, a phenoxy group, and a naphthyloxy group as a substituent.

Examples of the aryloxy group having 6 to 10 carbon atoms may include a phenoxy group and a naphthyl oxy group and these groups may have substituents selected from halogen atoms such as fluorine atom, chlorine atom, bromine atom or iodine atom, a hydroxyl group, an amino group, a methoxy group, an ethoxy group, an isopropyloxy group, a phenyl group, a naphthyl group, a phenoxy group, and a naphthyloxy group as a substituent.

Ar¹ and Ar² in the formula (1) respectively denote a divalent aromatic group which may have a substituent as described above, and as Ar¹ and Ar², particularly an unsubstituted phenylene group or an unsubstituted naphthylene group is preferable and 1,3-phenylene group, 1,4-phenylene group, 1,3-naphthalenediyl group, 1,4-naphthalenediyl group, 1,5-naphthalenediyl group, 1,6-naphthalenediyl group, 1,7-naphthalenediyl group, 2,6-naphthalenediyl group, 2,7-naphthalenediyl group, 3,3′-biphenylylene group, 3,4′-biphenylylene group, and 4,4′-biphenylylene group are preferable.

Further, k in the formula (1) denotes 0, 1, or 2 and Z¹ denotes CO (carbonyl group), or SO₂ (sulfonyl group), or COCO (dicarbonyl group). When k is 2, two Z¹ groups may be the same or different with each other and it is particularly preferable that Z¹ groups are the same.

The present invention is characterized in that, among Ar¹ and Ar² groups as described above, at least one of Ar¹ and Ar² has an acid group and when k is 1 or more, all of the groups represented by Ar¹ and Ar² are preferable to have acid groups.

Herein, examples of the acid groups are weak acid groups such as a carboxyl group (—COOH), a phosphonic acid group (—PO₃H₂) and a phosphoric acid group (—OPO₃H₂); strong acid groups such as a sulfonic acid group (—SO₃H) and a sulfonylimido group (—SO₂NHSO₂—R, wherein R denotes an alkyl group having 1 to 6 carbon atoms or an aryl group having 6 to 10 carbon atoms); and a superacid group such as a perfluoroalkylenesulfonic acid group, a perfluorophenylenesulfonic acid group, and a perfluoroalkylenesulfonylimido group. Among them, a strong acid group or a superacid group whose acid dissociation constant represented by a pKa value is 2 or lower is preferable, for example, a sulfonic acid group, a perfluoroalkylenesulfonic acid group, or a perfluorophenylenesulfonic acid group is preferable. When these acid groups are protonic acids, they may form salts with such as alkali metal ions, alkaline earth metal ions, or ammonium ion and the acid groups forming the salts can easily be turned back to free acid forms by ion exchange with acid treatment after formation of the copolymerization of the present invention.

Preferable examples of the compound represented by the formula (1) are, for example, the following (1)-1 to (1)-4:

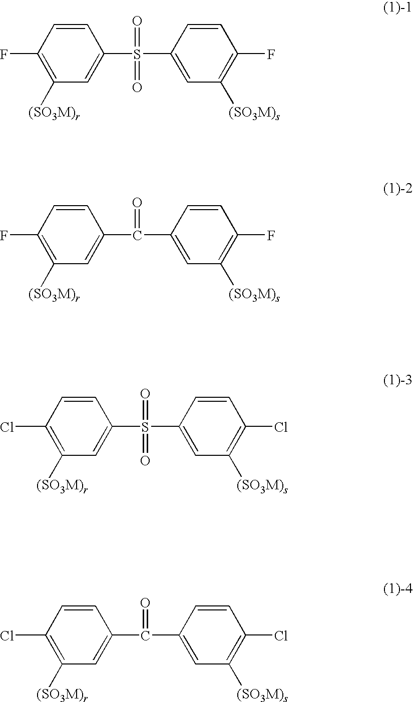

wherein, r and s each independently denote 0 or 1 and r+s is 1 or 2; M denotes hydrogen atom, potassium atom, sodium atom, or lithium atom; and when there are a plurality of M, they may be same or different.

It is preferable that the above-mentioned (B) should contain a compound represented by the formula (2).

Herein, the acid groups are characterized in that when j is 0, Ar³ has the acid groups, and when j is 1 or higher, at least one of Ar³ and Ar⁴ have the acid groups. Ar³ and Ar⁴ denote a divalent aromatic group and examples of the divalent aromatic group may be groups same as the above-mentioned groups for Ar¹ and Ar² and when j is 2, Ar³ and two Ar⁴ groups may be the same or different with each other. In addition, a phenolic hydroxyl group among the nucleophilic groups represented by Y¹ is a group which can be converted into a phenolate group with a proper base in the condensation reaction process and reacts as a nucleophilic group and also a group existing in form of an ether bond in the copolymer of the present invention and is thus not regarded as an acid group.

These divalent aromatic groups may be substituted with an alkyl group having 1 to 10 carbon atoms which may have a substituent, an alkoxy group having 1 to 10 carbon atoms which may have a substituent, an aryl group having 6 to 10 carbon atoms which may have a substituent, an aryloxy group having 6 to 10 carbon atoms which may have a substituent, and specific examples of the alkyl group, the alkoxy group, the aryl group, or the aryloxy group are those same as the exemplified above.

Ar³ and Ar⁴ in the formula (2) denote a divalent aromatic group which may have the above-mentioned substituent group and as Ar³ and Ar⁴, particularly an unsubstituted phenylene group, an unsubstituted biphenylylene group, or an unsubstituted naphthylene group is preferable and 1,3-phenylene group, 1,4-phenylene group, 1,3-naphthalenediyl group, 1,4-naphthalenediyl group, 1,5-naphthalenediyl group, 1,6-naphthalenediyl group, 1,7-naphthalenediyl group, 2,6-naphthalenediyl group, 2,7-naphthalenediyl group, 3,3′-biphenylylene group, 3,4′-biphenylylene group, or 4,4′-biphenylylene group is preferable.

In addition, j in the formula (2) denotes 0, 1 or 2; Q¹ denotes a direct bond or a group selected from the following groups. When j is 2, two Q¹ groups may be the same or different with each other, and two Q¹ groups are preferably the same as each other.

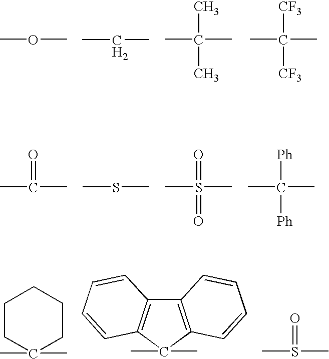

Preferable examples of the compound represented by the formula (2) include the following (2)-1 to (2)-12.

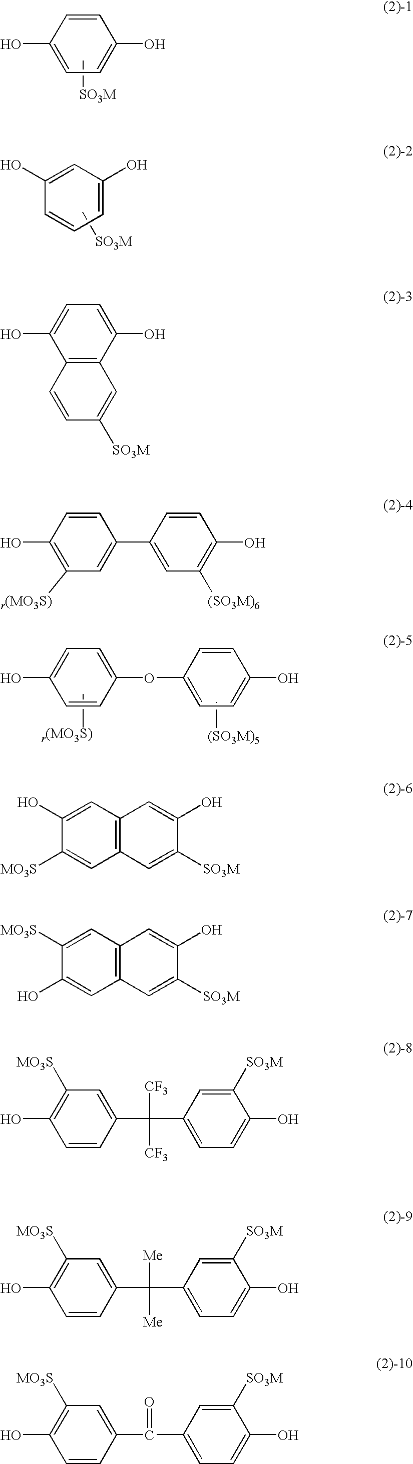

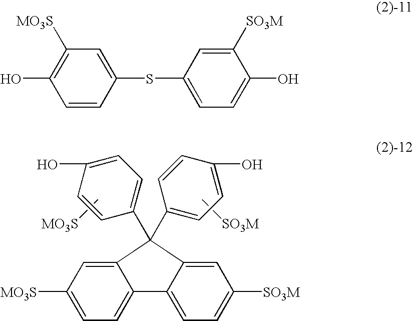

Next, monomers having substantially no acid group will be described. Herein, “having substantially no acid groups” means, similar to the above-mentioned hydroxyl group, a kind of acid groups which exists in a monomer as a nucleophilic group and disappears in the process of forming a copolymer is not regarded as an acid group in the present invention and therefore, even such a monomer having an acid group is regarded as monomers having substantially no acid group in the present invention.

The above-mentioned (C) is preferably a compound represented by the formula (3).

Ar⁵ and Ar⁶ in the formula (3) denote, as a divalent aromatic, a hydrocarbon based aromatic group such as a phenylene group, a naphthylene group, a biphenylylene group and a fluorenediyl group and a heterocyclic group such as a pyridinediyl group, a quinoxalinediyl group, and a thiophenediyl and preferably a divalent hydrocarbon based aromatic group. When m is 1, Ar⁵ and Ar⁶ may be the same or different, and when m is 2, Ar⁵ and two Ar⁶ groups may be the same or different.

These divalent aromatic groups may be substituted with an alkyl group having 1 to 10 carbon atoms which may have a substituent, azo alkoxy group having 1 to 10 carbon atoms which may have a substituent, an aryl group having 6 to 10 carbon atoms which may have a substituent, an aryloxy group having 6 to 10 carbon atoms which may have a substituent, a nitro group, and a benzoyl group and specific examples of the alkyl group, the alkoxy group, the aryl group, or the aryloxy group are those same as exemplified above.

As Ar⁵ and Ar⁶, particularly an unsubstituted phenylene group, or an unsubstituted naphthylene group is preferable and 1,3-phenylene group, 1,4-phenylene group, 1,3-naphthalenediyl group, 1,4-naphthalenediyl group, 1,5-naphthalenediyl group, 1,6-naphthalenediyl group, 1,7-naphthalenediyl group, 2,6-naphthalenediyl group, 2,7-naphthalenediyl group, 3,3′-biphenylylene group, 3,4′-biphenylylene group, or 4,4′-biphenylylene group is preferable.

In addition, m in the formula (3) denotes 0, 1, or 2 and Z² denotes CO, SO₂, or COCO. When m is 2, two Z² groups may be the same or different and it is preferable that two Z² groups are the same each other.

Preferable examples of the compound represented by the formula (3) include the following (3)-1 to (3)-9.

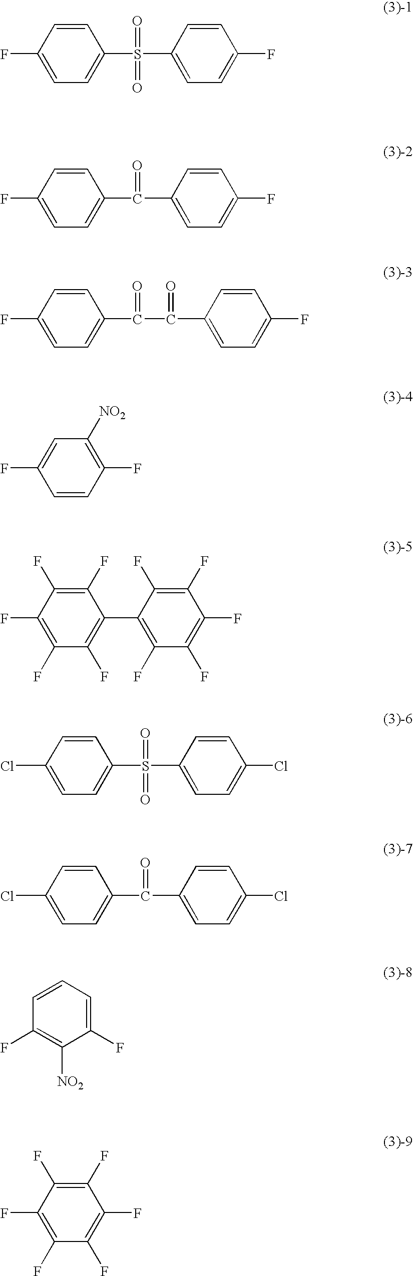

It is preferable that the above-mentioned (D) preferably contains a compound represented by the formula (4)

Ar⁷ and Ar⁸ in the formula (4) denote a divalent aromatic group and examples of the divalent aromatic group may be groups same as the above-mentioned groups for Ar⁵ and Ar⁶ and these divalent aromatic groups may be substituted with an alkyl group having 1 to 10 carbon atoms which may have a substituent, an alkoxy group having 1 to 10 carbon atoms which may have a substituent, an aryl group having 6 to 10 carbon atoms which may have a substituent, an aryloxy group having 6 to 10 carbon atoms which may have a substituent, and specific examples of the alkyl group, the alkoxy group, the aryl group, or the aryloxy group are those same as the exemplified above.

As Ar⁷ and Ar⁸, particularly an unsubstituted phenylene group, an unsubstituted biphenylylene group, or an unsubstituted naphthylene group is preferable and 1,3-phenylene group, 1,4-phenylene group, 1,3-naphthalenediyl group, 1,4-naphthalenediyl group, 1,5-naphthalenediyl group, 1,6-naphthalenediyl group, 1,7-naphthalenediyl group, 2,6-naphthalenediyl group, 2,7-naphthalenediyl group, 3,3′-biphenylylene group, 3,4′-biphenylylene group, or 4,4′-biphenylylene group is preferable.

In addition, n in the formula (4) denotes 0, 1 or 2; Q² denotes a direct bond or a group selected from the following groups. When n is 2, two Q² groups may be the same as or different each other, and two Q² groups are preferably the same each other.

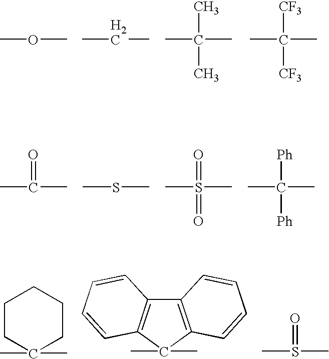

Preferable examples of the compound represented by the formula (4) include the following (4)-1 to (4)-26.

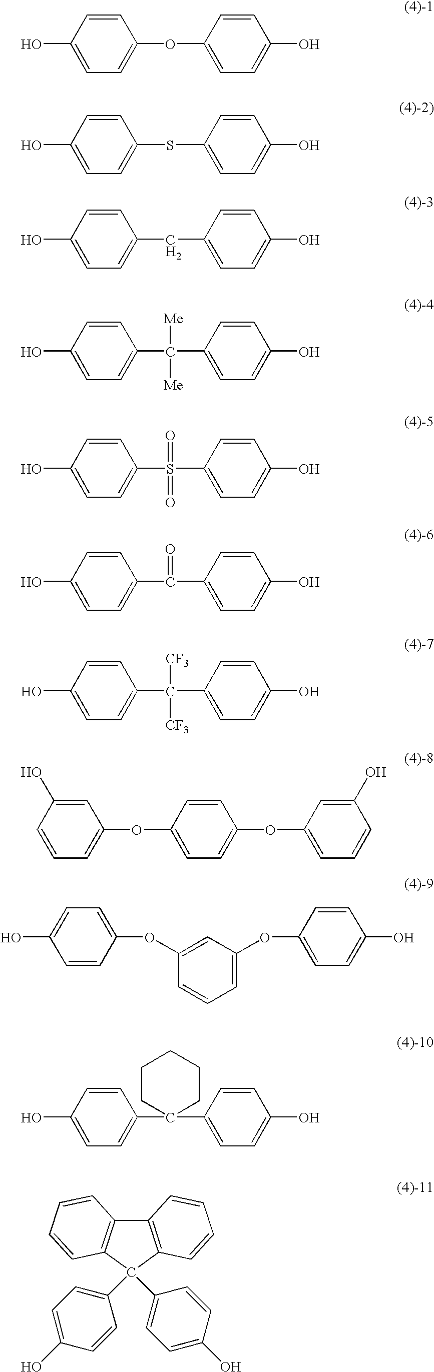

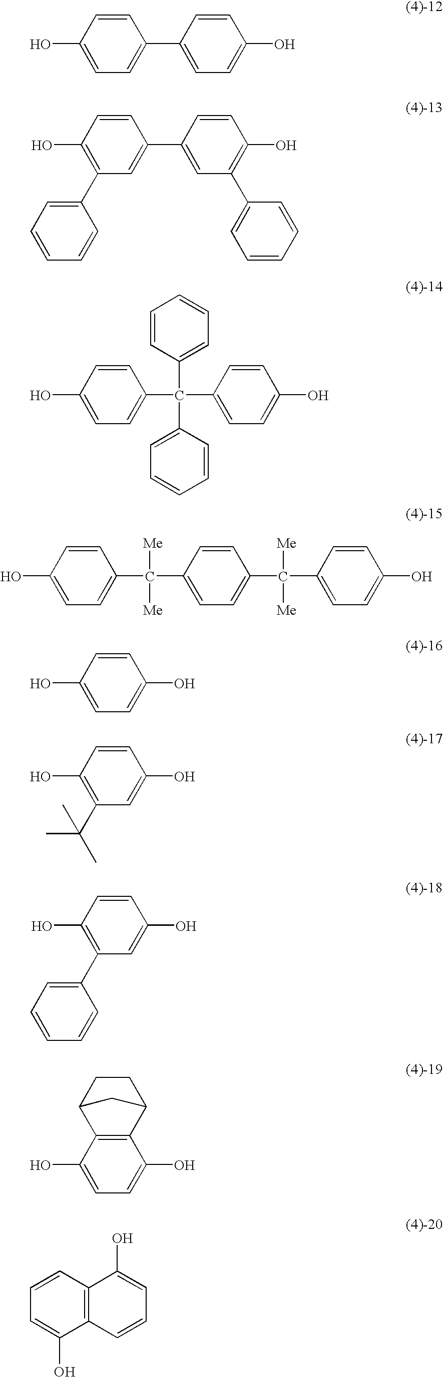

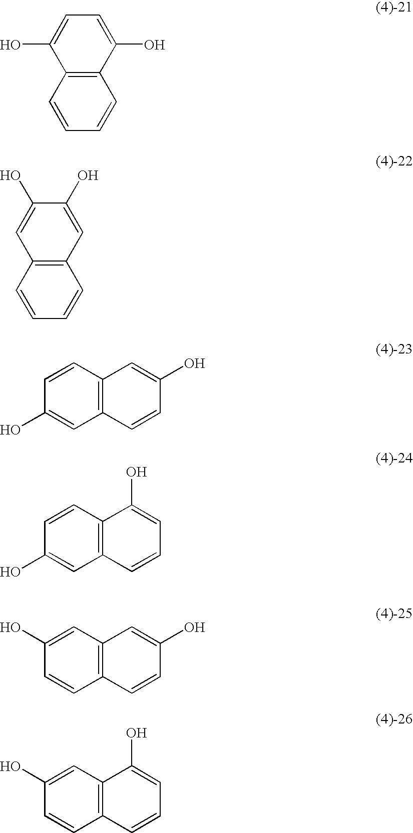

A copolymer of the present invention can be produced by either mixing a mixture of the above-mentioned (A), (B), (C), and (D), or mixing monomers having nucleophilic groups, for example, (B) and (D) and separately mixing monomers having leaving groups, for example, (A) and (C) and further mixing the respective mixtures, and successively subjecting to nucleophilic condensation reaction of the monomers having nucleophilic groups and the monomers having leaving groups.

A preferable copolymer of the present invention can be obtained using the compounds represented by the above-mentioned formulas (1) to (4) as monomers and mixing and condensing them. An example includes a method of carrying out nucleophilic condensation of the compounds represented by the formulas (1) to (4) in the presence of a base.

Specifically, the compounds represented by the formulas (1) to (4) and a basic compound are charged into a reaction solvent and mixed. The order of mixing is not particularly limited, however, preferable mixing method is previously charging the compound represented by the formula (2), the compound represented by the formula (4), the basic compound and the solvent, and then mixing the above-mentioned (1) and (3); or mixing the compounds represented by the formulas (1) to (4) and the solvent, and then charging and mixing the basic compound; or charging and mixing the compounds represented by the formulas (1) to (4), the basic compound and the solvent. In the condensation, the reaction temperature is preferably 20 to 300° C. and further preferably 50 to 250° C. and the reaction time can be carried out preferably 0.5 to 500 hours and more preferably 1 to 100 hours. In addition, with respect to the pressure at the time of the reaction, the pressure may be pressurized or reduced, and normal pressure (about atmospheric pressure) is preferable since it is convenient in terms of facilities. As a reaction solvent, alcohol based solvents such as methanol, ethanol, isopropanol, and butanol; ether based solvents such as diethyl ether, dibutyl ether, diphenyl ether, tetrahydrofuran, dioxane, dioxolane, ethylene glycol monomethyl ether, ethylene glycol monoethyl ether, propylene glycol monomethyl ether, and propylene glycol monoethyl ether; ketone based solvents such as acetone, methyl isobutyl ketone, methyl ethyl ketone, and benzophenone; halogen based solvents such as chloroform, dichloromethane, 1,2-dichloroethane, 1,1,2,2-tetrachloroethane, chlorobenzene, and dichlorobenzene; amide based solvents such as N,N-dimethylacetamide (hereinafter, sometimes abbreviated as DMAc), N-methylacetamide, N,N-dimethylformamide (hereinafter, sometimes abbreviated as DMF), N-methylformamide, formamide, and N-methyl-2-pyrrolidone (hereinafter, sometimes abbreviated as NMP); esters such as methyl formate, methyl acetate, and γ-butyrolactone; nitriles such as acetonitrile and butyronitrile; sulfoxydimethyl gulf oxide (hereinafter, sometimes abbreviated as DMSO), diphenylsulfone, sulfolane, and the like can be used. The reaction solvents may be used alone, or two or more kinds of the reaction solution may be used in combination. The used amount of the reaction solvents is 1.0 to 200.0 times by weight, preferably 2.0 to 100.0 times by weight, based on the total weight of the used monomers. Here, it is preferable to remove water of by-product in the initial period of condensation reaction or during the condensation reaction. The method of removing the water to be employed may be the method of removing water in form of an azeotropy by making toluene and xylene coexist in the reaction system and the method of dehydrating by making water absorbent such as a molecular sieve coexist in the reaction system. As the above-mentioned basic compound, sodium hydroxide, potassium hydroxide, sodium carbonate, potassium carbonate, sodium hydrogen carbonate, or potassium hydrogen carbonate may be used, and the mixture of two or more basic compounds may be used and especially potassium carbonate, sodium carbonate, or sodium hydroxide is preferable. Here, the used amount of the basic compound may be 0.90 to 10.00 times by mole equivalent, preferably 1.00 to 3.00 times by mole equivalent based on the total mole equivalent to the nucleophilic groups in the used monomers in the condensation reaction.

Another embodiment in a preferable production method of the copolymer of the present invention may be a method of previously reacting the compound represented by the formula (2) and the compound represented by the formula (4) with the basic compound, and then charging the compounds represented the formula (1) and the compound represented by the formula (3) and mixing the compounds, and successively carrying out condensation. That is, after compound represented by the formula (2), the compound represented by the formula (4), and the basic compound are mixed in the reaction solvent and, if necessary, heating treatment is carried out to react the basic compound with the compound represented by the formula (2) and the compound represented by the formula (4), the compounds represented by the formula (1) and the compound represented by the formula (3) are added to the mixture and then the condensation reaction is carried out. The reaction solvent to be used and used amount thereof and the basic compound to be used and used amount thereof are the same as described above and the reaction temperature and the reaction time relevant to the condensation reaction are in the same ranges as described above. Removal of the water of by-product may be carried out in the same manner as described above or it may be a method of sufficiently removing water in form of azeotropy by making toluene and xylene coexist in the reaction system upon mixing the compound represented by the formula (2), the compound represented by the formula (4), and the basic compound with the reaction solvent, and successively adding the compound represented by the formula (1) and the compound represented by the formula (3) to the mixture and carrying out condensation reaction.

Consequently, the copolymer of the present invention is obtained. With respect to the copolymer, the weight composition ratio of the structural unit into which the acid group is introduced and the structural unit into which substantially no acid group is introduced is not particularly limited, however, in general, the ratio of [structural unit into which the acid group is introduced]:[structural unit into which substantially no acid group is introduced] is 3:97 to 70:30, preferably 5:95 to 45:55, more preferably 10:90 to 40:60, and even more preferably 20:80 to 35:65. The copolymer having the ratio of the structural unit into which the acid group is introduced within the above-mentioned range, becomes a polymer electrolyte membrane having both of proton conductivity and water-proofness at a high level, when the copolymer is used for a polymer electrolyte membrane of a separating membrane of a fuel cell.

Here, the weight composition ratio of the structural unit into which the acid group is introduced and the structural unit into which substantially no acid group is introduced can be controlled by the used amount of the monomers and, for example, the weight composition ratio can be properly controlled by changing the charging (mixing) mole ratio in the initial reaction stage of the total mole amount of the monomers having acid groups, containing the compound represented by the formula (1) and the compound represented by the formula (2) and the total mole amount of the monomers having substantially no acid group, containing the compound represented by the formula (3) and the compound represented by the formula (4).

On the basis of equivalent amount of the acid group per 1 g of the copolymer, that is, the ion exchange capacity, the introduction amount of the acid group in the entire copolymer is preferably 0.1 meq/g to 4.0 meq/g, more preferably 0.5 meq/g to 2.5 meq/g, and even more preferably 1.3 meq/g to 2.3 meq/g. The reason for that the ion exchange capacity is preferably in the above-mentioned range is the same reason for the ratio of the content weight the structural unit into which the acid group is introduced in the copolymer and the ion exchange capacity can also be controlled arbitrarily in the same manner of changing the charging (mixing) mole ratio of the respective monomers in the initial reaction stage.

The average molecular weight of the copolymer of the present invention is preferably 5000 to 1000000 and especially further preferably 15000 to 200000 on the basis of the number average molecular weight converted into polystyrene.

The above-mentioned average molecular weight can be controlled in accordance with such the ratio of total mole equivalent amount of the nucleophilic groups of the monomers to be used and the total mole equivalent of the leaving groups and the reaction time.

Next, the case of using the copolymer of the present invention for a separating membrane (polymer electrolyte membrane) of an electrochemical device such as a fuel cell will be described.

In this case, the copolymer of the present invention may be used, in general, in form of a membrane. A method for converting the copolymer into a membrane is not particularly limited; however a method of forming a membrane from a solution (a solution cast method) is preferably employed.

Specifically, the copolymer is dissolved in a suitable solvent and the obtained solution is applied to a glass plate and the solvent is removed to form a membrane. The solvent to be used for membrane formation is not particularly limited if it is capable of dissolving the copolymer and removing thereafter and water and non-protonic polar solvents such as N,N-dimethylformamide, N,N-dimethylacetamide, N-methyl-2-pyrrolidone, and dimethyl sulfoxide; chlorinated solvents such as dichloromethane, chloroform, 1,2-dichloroethane, chlorobenzene, and dichlorobenzene; alcohols such as methanol, ethanol, and propanol; and alkylene glycol monoalkyl ethers such as ethylene glycol monomethyl ether, ethylene glycol monoethyl ether, propylene glycol monomethyl ether, and propylene glycol monoethyl ether are preferably used. They may be used alone and if necessary two or more kinds of solvents may be used in form of a mixture. Especially, DMSO, DMF, DMAc, and NMP are preferable, having high solubility of polymers.

The thickness of the membrane is not particularly limited and preferably 10 to 300 μm and particularly preferably 20 to 100 μm. If a film is thinner than 10 μm, the practical strength is sometimes insufficient and if a film is thicker than 300 μm, the membrane resistance becomes high and the properties of the electrochemical device tend to deteriorate. The thickness of the membrane can be controlled by the concentration of the solution and the application thickness of the solution to the substrate.

As a purpose of improving the various kinds of physical properties of the polymer electrolyte membrane, such as a plasticizer, a stabilizer, and a release agent to be used for common polymers may be added to the copolymer of the present invention. In addition, it is also possible that another polymer is composite alloyed with the copolymer of the present invention by a method for mixing and cocasting the polymer in the same solvent.

To make water control easy in application to a fuel cell, it is also known that inorganic or organic fine particles are added as a water retention agent. Any of these conventionally known methods can be employed unless it is contradictory for the purpose of the present invention. Further, in order to improve the mechanical strength of the polymer electrolyte membrane comprising the polymer electrolyte containing the copolymer of the present invention, electron beam and radiation beam may be radiated to cross-link the polymer electrolyte composing the polymer electrolyte membrane.

In addition, in order to further improve strength, flexibility, and durability of the polymer electrolyte membrane, it is allowed to impregnate a porous substrate with the copolymer of the present invention to produce a polymer electrolyte composite membrane. A conventionally known method can be employed for a compositing method. The porous substrate is not particularly limited if it can satisfy the above-mentioned purpose of the use and examples may include, such as a porous membrane, a woven fabric, a non-woven fabric, and fibril and they may be used regardless of the shape and quality of material thereof.

When the polymer electrolyte composite membrane using the copolymer of the present invention is used as a separating membrane for fuel cells, the thickness of the porous substrate is 1 to 100 μm, preferably 3 to 30 μm, and more preferably 5 to 20 μm; the pore diameter is 0.01 to 100 μm and preferably 0.02 to 10 μm; and the porosity is 20 to 98% and preferably 40 to 95%. If the thickness of the porous substrate is too thin, the effect of reinforcing the strength after compositing or the reinforcing effect of imparting flexibility and durability becomes insufficient and thus gas leakage (cross leakage) is caused easily. In addition, if the thickness of the membrane is too thick, the electric resistance becomes high and the obtained composite membrane becomes improper as the separating membrane of a solid polymer fuel cell. If the pore diameter is too small, it becomes difficult to fill the copolymer of the present invention and if it is too high, the reinforcing effect on the solid polymer electrolyte becomes weak. If the porosity is too low, the resistance of the composite membrane becomes high and if it is too high, the strength of the porous substrate itself generally becomes weak and the reinforcing effect is reduced.

From the viewpoint of the heat resistance and the reinforcing effect of the physical strength, the above-mentioned porous substrate is preferably a substrate comprising an aliphatic based polymer, an aromatic based polymer, or a fluorine-containing polymer.

Next, a fuel cell of the present invention will be described. As the fuel cell using the polymer electrolyte membrane, while there are, for example a solid polymer fuel cell using hydrogen gas as fuel and a direct methanol solid polymer fuel cell to which methanol as fuel is directly supplied, the copolymer of the present invention may be used preferably for both.

Examples of the fuel cell obtained according to the present invention may be those using the copolymer of the present invention for a polymer electrolyte membrane and/or a polymer electrolyte composite membrane and those using the polymer electrolyte of the present invention for a polymer electrolyte in a catalyst layer.

The fuel cell using the copolymer of the present invention for a polymer electrolyte membrane or a polymer electrolyte composite membrane can be produced by conjugating a catalyst and a gas diffusion layer on both sides of the polymer electrolyte membrane or the polymer electrolyte composite membrane. Conventionally known materials can be used for the gas diffusion layer and a porous carbon woven fabric, carbon non-woven fabric, or carbon paper is preferable for efficiently transporting a raw material gas to the catalyst.

Herein, the catalyst is not particularly limited as far as it can activate redox reaction of hydrogen or oxygen and conventionally known ones may be used, however, fine particles of platinum are preferably used. Fine particles of platinum are often preferably used with being supported on particulate or fibrous carbon such as activated carbon and graphite. In addition, a paste obtained by mixing platinum supported on carbon with an alcohol solution of a perfluoroalkylsulfonic acid resin as a polymer electrolyte is applied to a gas diffusion layer, a polymer electrolyte membrane, or a polymer electrolyte composite membrane and dried to obtain the catalyst layer. Specific methods may be conventionally known method such as those described in, for example, J. Electrochem. Soc. Electrochemical Science and Technology, 1988, 135(9), 2209.

Examples of the fuel cell using the copolymer of the present invention as the polymer electrolyte in the catalyst layer may include those using the copolymer of the present invention in place of a perfluoroalkylsulfonic acid resin composing the above-mentioned catalyst layer. When the catalyst layer containing the copolymer of the present invention is used, the polymer electrolyte membrane is not limited to the membrane using the copolymer of the present invention and conventionally known polymer electrolyte membranes may be used.

When the catalyst layer using the copolymer of the present invention is obtained, a solvent to be used for preparing a catalyst paste is arbitrary and not particularly limited; however it is desired that the solvent be capable of dissolving components besides the solvents composing the catalyst paste, or dispersing the components evenly in molecular level, or forming agglomerates in nano- to micro-level and dispersing the agglomerates. The solvent may be a single solvent or a mixture of a plurality of solvents and those exemplified as the solvents usable when a membrane of the copolymer of the present invention is formed, may be used.

Other components composing the catalyst paste are arbitrary and not particularly limited; however the components may sometimes contain a water-repelling material such as PTFE to improve the water-repellency of the catalyst layer, a pore forming material such as calcium carbonate to improve the gas diffusion property of the catalyst layer, a stabilizer such as a metal oxide and a polymer having phosphonic acid group to improve the durability.

The catalyst paste is obtained by mixing the above-mentioned polymer electrolyte, a catalytic material and/or a conductive material supporting a catalytic material on a surface, a solvent, and other components by a conventionally known method. The mixing method may include an ultrasonic dispersion apparatus, a homogenizer, a ball mill, a planetary ball mill, and a sand mill.

A method of directly applying the catalyst paste is not particularly limited and an already known method such as a die coater, a screen printing, a spraying method, and an ink jet method can be employed; however a spraying method is preferable since its operation is industrially convenient.

As the spraying method of the catalyst paste, the apparatus and method disclosed in, for example, Japanese Unexamined Patent Publication No. 2004-89976 can be specifically illustrated and the method can be carried out using them. That is, a polymer electrolyte is set on a stage and a catalyst ink is directly applied to the polymer electrolyte. In a spraying method, the catalyst ink is sprayed in particle state out of a jetting outlet and is adhered on the polymer electrolyte. It is desired that the stage should be heated to remove the solvent quickly after application and the temperature is preferably 50° C. to 150° C. If the temperature is within the above-mentioned range, the solvent of the catalyst ink is easy to be removed quickly and the tendency of thermal damages on the polymer electrolyte membrane is small and therefore, it is preferable. As described, the solvent is removed by heating the stage successively to the application by the spraying method to produce the catalyst layer on the polymer electrolyte membrane. For the purpose of removing the solvent completely, the membrane on which the catalyst layer is formed may be put in such as a heated oven and dried or, if necessary, drying in a vacuum can be carried out. To remove the solvent more quickly, a preferable solvent composing the catalyst paste is a solvent having a boiling point of 150° C. or lower and water, alcohol based solvents such as methanol and ethanol, ether based solvents such as diethyl ether and tetrahydrofuran, and solvent mixture thereof may be used and the copolymer of the present invention is also excellent in that it is easy to dissolve in these solvents. The catalyst paste may be sprayed a plurality of times and respective layers obtained by spraying may be coated over on the polymer electrolyte membrane to form a multi-layer coating.

Hereinafter, the invention will be described with reference to Examples, however it is not intended at all that the invention be limited to the illustrated Examples.

### Measurement of Molecular Weight:

The number average molecular weight (Mn) based on polystyrene standard calibration, was measured by gel permeation chromatography (GPC) in the following conditions.
GPC measurement apparatus: HLC-8220 GPC, manufactured by TOSOH Co., Ltd.
Column: TSKgel GHMHR-M, manufactured by Showa Denko K.K.
Column temperature: 40° C.

mobile phase solvent: DMAc (adding LiBr in a concentration of 10 mmol/dm³)

solvent flow rate: 0.5 mL/min

### Measurement of Proton Conductivity:

Measured by an AC method at a temperature of 80° C. and relative humidity of 90%.

### Measurement of Ion Exchange Capacity:

Measured by a titration method.

### Measurement of Water Absorption Ratio:

After a dried polymer electrolyte membrane was weighed and immersed in deionized water at 100° C. for 2 hours, the water absorption ratio was calculated from the increase of the membrane weight amount and the ratio to the above-mentioned dried membrane was calculated.

### Example 1

### Production of Copolymer A

Polymerization was carried out by charging a 200 mL separable flask equipped with a Dean-Stark apparatus with 3.50 g (15.33 mmol) of potassium hydroquinonesulfonate, 6.29 g (33.76 mmol) of 4,4′-dihydroxybiphenyl, and 7.36 g (53.24 mmol) of potassium carbonate and carrying out azeotropic dehydration in 121 mL of dimethyl sulfoxide and 70 mL of toluene under argon atmosphere at bath temperature of 150° C. (inner temperature of 130±5° C.) for 1.5 hours. After 1.5 hours, toluene was removed to the outside of the system and the reaction product was spontaneously cooled to room temperature. Thereafter, 9.03 g (18.40 mmol) of 3,3′-sulfonylbis(potassium 6-fluorobenzenesulfonate) and 7.80 g (30.69 mmol) of 4,4′-difluorodiphenylsulfone were added to the reaction product and further reaction was carried out at an inner temperature of 150° C. for 11 hours. The reaction was traced by GPC measurement. On completion of the reaction, the reaction solution was spontaneously cooled to 80° C. and dropwise added to 3 L of an aqueous 2 M hydrochloric acid solution. The precipitated white polymer was filtered and washed until pH of the washing filtrate became about 7 and thereafter, a step of treatment with water at 80° C. for 2 hours was repeated twice. The resulting polymer was dried by an oven (80° C.) to obtain 20.86 g (yield 92%) of the following copolymer A. Thereafter, the following dried polymer was dissolved in N-methylpyrrolidone and then filtered to obtain a solvent solution in a concentration of 18% by weight. Then, the solution was applied to a glass substrate and N-methylpyrrolidone was removed at 80° C. in a fully evacuated oven for about 5 hours. Thereafter, a step of treatment with 2N hydrochloric acid for 1 hour was repeated twice and washed with flowing water (deionized water) for 8 hours to obtain a polymer electrolyte membrane. A thickness of the membrane was 33 μm.

### Copolymer A

The copolymer A was a polymer having the following structural units.

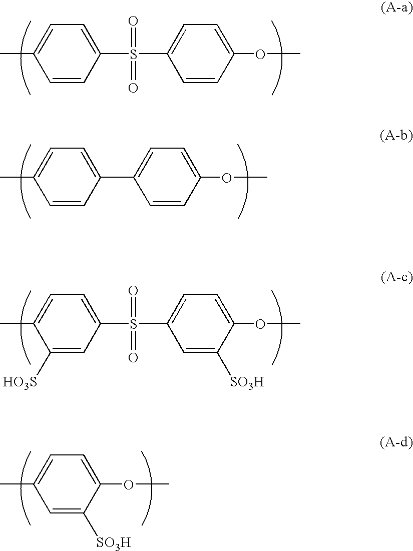

The molar ratio of the respective structural units (A-a), (A-b), (A-c), and (A-d) calculated from the charged amounts to the total of the above-mentioned structural units: (A-a):(A-b):(A-c):(A-d)=2.00:2.20:1.20:1.00
The ion exchange capacity calculated from the molar ratio of the above-mentioned structural units: 2.30 meq/g

### Mn 8.10×10⁴

Actually measured value of ion exchange capacity: 2.10 meq/g
Membrane production: NMP solution cast method: membrane thickness 33 μm
Proton conductivity: 1.56×10⁻¹ S/cm
Water absorption ratio: 169%

### Example 2

### Production of Copolymer B

Polymerization was carried out by charging a 200 mL separable flask equipped with a Dean-Stark apparatus with 3.50 g (15.33 mmol) of potassium hydroquinonesulfonate, 7.87 g (42.25 mmol) of 4,4′-dihydroxybiphenyl, and 8.65 g (62.57 mmol) of potassium carbonate and carrying out azeotropic dehydration in 138 mL of dimethyl sulfoxide and 70 mL of toluene under argon atmosphere at bath temperature of 150° C. (inner temperature of 130±5° C.) for 1.5 hours. After 1.5 hours, toluene was removed to the outside of the system and the reaction product was spontaneously cooled to room temperature. Thereafter, 9.03 g (18.40 mmol) of 3,3′-sulfonylbis(potassium 6-fluorobenzenesulfonate) and 9.96 g (39.18 mmol) of 4,4′-difluorodiphenylsulfone were added to the reaction product and further reaction was carried out at an inner temperature of 150° C. for 5 hours. The reaction was traced by GPC measurement. On completion of the reaction, the reaction solution was spontaneously cooled to 80° C. and dropwise added to 3 L of an aqueous 2 M hydrochloric acid solution. The precipitated white polymer was filtered and washed until pH of the washing filtrate became about 7 and thereafter, a step of treatment with water at 80° C. for 2 hours was repeated twice. The resulting polymer was dried by an oven (80° C.) to obtain 23.62 g (yield 91%) of the following copolymer B. The membrane production was carried out according to Example 1.

### Copolymer B

The copolymer B was a polymer having the following structural units.

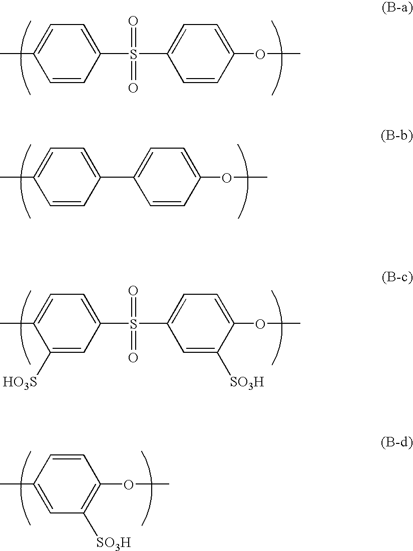

The molar ratio of the respective structural units (B-a), (B-b), (B-c), and (B-d) calculated from the charged amounts to the total of the above-mentioned structural units: (B-a):(B-b):(B-c):(B-d)=2.56:2.76:1.20:1.00
The ion exchange capacity calculated from the molar ratio of the above-mentioned structural units: 2.00 meq/g

### Mn 8.20×10⁴

Actually measured value of ion exchange capacity: 1.80 meq/g
Membrane production: NMP solution cast method: membrane thickness 26 μm
Proton conductivity: 8.84×10⁻² S/cm
Water absorption ratio: 94%

### Comparative Example 1

### Production of Copolymer C

Polymerization was carried out by charging a 200 mL separable flask equipped with a Dean-Stark apparatus with 6.18 g (27.09 mmol) of potassium hydroquinonesulfonate, 10.00 g (39.33 mmol) of 4,4′-difluorodiphenylsulfone, 2.28 g (12.25 mmol) of 4,4-dihydroxybiphenyl, and 5.98 g (43.26 mmol) of potassium carbonate and carrying out azeotropic dehydration in 74 mL of dimethyl sulfoxide and 40 mL of toluene under argon atmosphere at bath temperature of 150° C. (inner temperature of 130±5° C.) for 3 hours. After 3 hours, toluene was removed to the outside of the system and reaction was carried out at an inner temperature of 150° C. for 12 hours. The reaction was traced by GPC measurement. On completion of the reaction, the reaction solution was spontaneously cooled to 80° C. and dropwise added to 3 L of an aqueous 2 M hydrochloric acid solution. The precipitated white polymer was filtered and washed until pH of the washing filtrate became about 7 and thereafter, a step of treatment with water at 80° C. for 2 hours was repeated twice. The resulting polymer was dried by an oven (80° C.) to obtain 14.67 g (yield 92%) of the following copolymer C. The membrane production was carried out according to Example 1.

### Copolymer C

The copolymer C was a polymer having the following structural units.

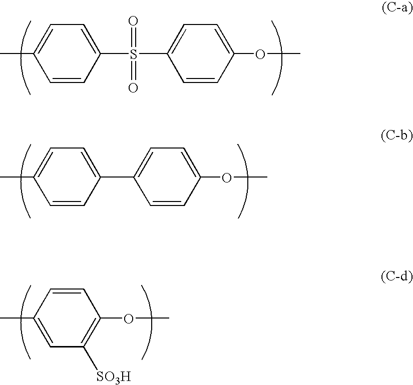

The molar ratio of the respective structural units (C-a), (C-b), and (C-c) calculated from the charged amounts to the total of the above-mentioned structural units: (C-a):(C-b):(C-c)=1.45:0.45:1.00
The ion exchange capacity calculated from the molar ratio of the above-mentioned structural units: 1.71 meq/g

### Mn 4.06×10⁴

Actually measured value of ion exchange capacity: 1.56 meq/g
Membrane production: NMP solution cast method: membrane thickness 54 μm
Proton conductivity: 4.60×10⁻² S/cm
Water absorption ratio: 302%

### Comparative Example 2

### Production of Copolymer D

Polymerization was carried out by charging a 500 mL separable flask equipped with a Dean-Stark apparatus with 12.74 g (50.10 mmol) of 4,4′-difluorodiphenylsulfone, 18.62 g (100.00 mmol) of 4,4′-dihydroxybiphenyl, and 25.08 g (50.00 mmol) of 3,3′-sulfonyl bis(potassium 6-fluorobenzenesulfonate), 15.20 g (110.00 mmol) of potassium carbonate and carrying out azeotropic dehydration in 160 mL of N-methyl-2-pyrrolidone and 80 mL of toluene under argon atmosphere at inner temperature of 140° C. for 5 hours. After 3 hours, toluene was removed to the outside of the system and reaction was carried out at an inner temperature of 170° C. for 8 hours. The reaction was traced by GPC measurement. On completion of the reaction, the reaction solution was spontaneously cooled to room temperature and dropwise added to 500 mL of an aqueous 2 M hydrochloric acid solution. After the precipitated white polymer was washed with water, the polymer was pulverized to powder and then was washed again with water until pH of the washing water became about 7. Thereafter, a step of treatment with water at 95° C. for 2 hours was repeated twice. The resulting polymer was dried in reduced pressure by an oven (60° C.) to obtain 45.31 g (yield 93%) of the following polymer. The membrane production was carried out according to Example 1.

### Copolymer D

The copolymer D was a polymer having the following structural units.

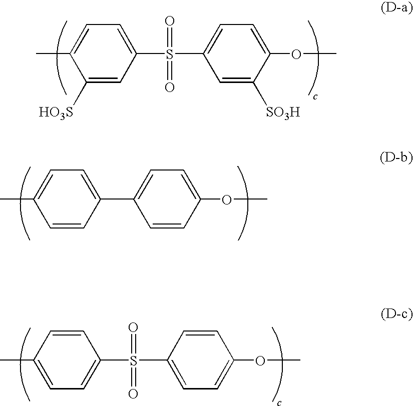

The molar ratio of the respective structural units (D-a), (D-b), and (D-c) calculated from the charged amounts to the total of the above-mentioned structural units: (D-a):(D-b):(D-c)=1.00:2.00:1.02
The ion exchange capacity calculated from the molar ratio of the above-mentioned structural units: 2.08 meq/g

### Mn 7.70×10⁴

Actually measured value of ion exchange capacity: 1.97 meq/g
Membrane production: NMP solution cast method: membrane thickness 26 μm
Proton conductivity: 0.97×10⁻¹ S/cm
Water absorption ratio: 460%

### Example 3

### Production of Copolymer E

Polymerization was carried out by charging a 200 mL separable flask equipped with a Dean-Stark tube with 3.00 g (13.14 mmol) of potassium hydroquinonesulfonate, 8.31 g (24.57 mol) of 4,4′-dihydroxy-3,3′-diphenylbiphenyl, and 5.42 g (39.21 mmol) of potassium carbonate and carrying out azeotropic dehydration in 105 mL of dimethyl sulfoxide and 60 mL of toluene under argon atmosphere at bath temperature of 150° C. (inner temperature of 130±5° C.) for 2 hours. After 2 hours, toluene was removed to the outside of the system and the reaction product was spontaneously cooled to room temperature. Thereafter, 7.17 g (15.77 mmol) of 4,4′-difluorobenzophenone-3,3′-dipotassium disulfonate and 5.57 g (21.90 mmol) of 4,4-difluorodiphenylsulfone were added to the reaction product and further reaction was carried out at an inner temperature of 150° C. for 25 hours. The reaction was traced by GPC measurement. On completion of the reaction, the reaction solution was spontaneously cooled to 80° C. and dropwise added to 3 L of an aqueous 2 M hydrochloric acid solution. The precipitated white polymer was filtered and washed until pH of the washing filtrate became about 7 and thereafter, a step of treatment with water at 80° C. for 2 hours was repeated twice. The resulting polymer was dried by an oven (80° C.) to obtain 18.96 g (yield 91%) of the following copolymer E. Thereafter, the membrane production was carried out according to Example 1.

### Copolymer E

The copolymer E was a polymer having the following structural units.

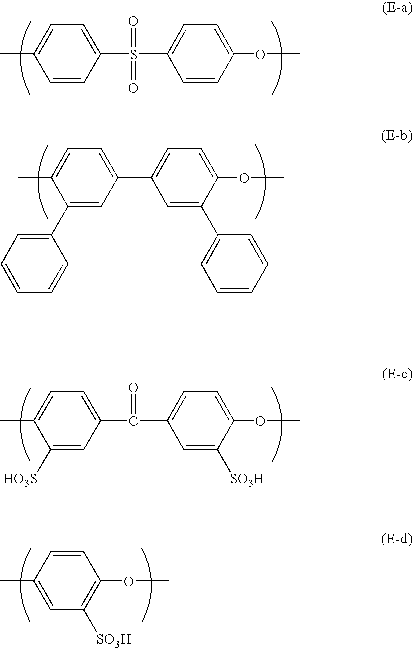

The molar ratio of the respective structural units (E-a), (E-b), (E-c), and (E-d) calculated from the charged amounts to the above-mentioned structural units: (E-a):(E-b):(E-c):(E-d)=1.67:1.87:1.20:1.00
The ion exchange capacity calculated from the molar ratio of the above-mentioned structural units: 2.00 meq/g

### Mn 6.2×10⁴

Actually measured value of ion exchange capacity: 1.90 meq/g
Membrane production: NMP solution cast method: membrane thickness 33 μm
Proton conductivity: 0.95×10⁻¹ S/cm
Water absorption ratio: 88%

### Example 4

### Production of Copolymer F

Polymerization was carried out by charging a 200 mL separable flask equipped with a Dean-Stark apparatus with 3.00 g (13.14 mmol) of potassium hydroquinonesulfonate, 5.79 g (17.11 mmol) of 4,4′-dihydroxy-3,3′-diphenylbiphenyl, 3.91 g (17.11 mmol) of 2,2′-bis(4-hydroxyphenyl)propane, 7.74 g (15.77 mmol) of 3,3′-sulfonyl bis(potassium 6-fluorobenzenesulfonate), 8.04 g (31.60 mmol) of 4,4′-difluorodiphenylsulfone, and 6.87 g (49.74 mmol) of potassium carbonate and carrying out azeotropic dehydration in 114 mL of dimethyl sulfoxide and 40 mL of toluene under argon atmosphere at bath temperature of 150° C. (inner temperature of 130±5° C.) for 2 hours. After 2 hours, toluene was removed to the outside of the system and the reaction was further carried out at 150° C. for 3 hours. The reaction was traced by GPC measurement. On completion of the reaction, the reaction solution was spontaneously cooled to 80° C. and dropwise added to 1 L of an aqueous 2 M hydrochloric acid solution. The precipitated polymer was filtered and washed until pH of the washing filtrate became about 7 and thereafter, a step of treatment with water at 80° C. for 2 hours was repeated twice. The resulting polymer was dried by an oven (80° C.) to obtain 23.31 g (yield 87%) of the following copolymer F. The membrane production was carried out according to Example 1.

### Copolymer F

The copolymer F was a polymer having the following structural units.

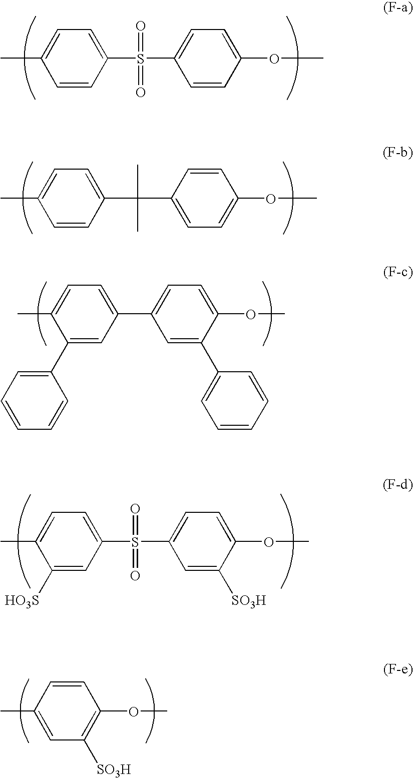

The molar ratio of the respective structural units (F-a), (F-b), (F-c), (F-d), and (F-e) calculated from the charged amounts to the total of the above-mentioned structural units: (F-a):(F-b):(F-c):(F-d):(F-e)=2.40:1.30:1.30:1.20:1.00
The ion exchange capacity calculated from the molar ratio of the above-mentioned structural units: 1.80 meq/g

### Mn 3.3×10⁴

Actually measured value of ion exchange capacity: 1.62 meq/g
Membrane production: NMP solution cast method: membrane thickness 60 μm
Proton conductivity: 0.62×10⁻¹ S/cm
Water absorption ratio: 104%

### Example 5

### Production of Catalyst Paste

A uniform copolymer A solution (concentration of copolymer A: 5% by weight) was produced by mixing 95 g of a solvent mixture of water:ethanol=1:9 (ratio by weight) and 5 g of the copolymer A obtained in Example 1. Separately, 0.64 g of platinum-supporting carbon (SA 50 BK, manufactured by N.E. CHEMCAT CORPORATION; platinum support amount 50% by weight) was charged to 11 mL of ethanol and further 1.05 g of the previously prepared copolymer A solution was added to the mixture. After the obtained mixture was treated for 1 hour by ultrasonic treatment, it was stirred by a stirrer for 6 hours to obtain a catalyst ink A.

### [Production of Polymer Electrolyte Membrane]

Referring to Japanese Unexamined Patent Publication No. 2005-139432, a polymer electrolyte membrane comprising the block copolymer type polymer electrolyte represented by the following formula was obtained. Specifically, a first polymer compound having ion exchange groups and a second polymer compound having substantially no ion exchange group were respectively synthesized as described below and they were further subjected to coupling to synthesize the block copolymer type polymer electrolyte.

### (Synthesis of First Polymer Compound)

To a flask provided with an azeotropic distillation apparatus was added 283.68 g of 4,4′-difluorodiphenylsulfone-3,3′-dipotassium disulfonate, 120.00 g of Potassium 2,5-dihydroxybenzenesulfonate, 1778 g of DMSO, and 279 g of toluene under argon atmosphere and while they were being stirred at room temperature, bubbling of argon gas was carried out for 1 hour.

Thereafter, 76.29 g of potassium carbonate was added to the obtained mixture and the mixture was heated and stirred at 140° C. for azeotropic dehydration. Thereafter, while toluene was removed by distillation, heating was continued to obtain a DMSO solution of the first polymer compound. The total heating time was 16 hours. The obtained solution was spontaneously cooled at room temperature.

The first polymer compound had Mn of 3.0×10⁴.

### (Synthesis of Second Polymer Compound)

To a flask provided with an azeotropic distillation apparatus was added 247.55 g of 4,4′-difluorodiphenylsulfone, 164.44 g of 2,6-dihydroxynaphthalene, 902 g of DMSO, 902 g of NMP, and 310 g of toluene under argon atmosphere and while they were being stirred at room temperature, bubbling of argon gas was carried out for 1 hour.

Thereafter, 156.09 g of potassium carbonate was added to the obtained mixture and the mixture was heated and stirred at 100° C. for vacuum azeotropic dehydration. Thereafter, toluene was removed by distillation after 17 hours and thereafter, heating was further continued at 100° C. The total heating time was 19 hours. The obtained solution was spontaneously cooled at room temperature to obtain a NMP/DMSP mixed solution of the second polymer compound.

The second polymer compound had Mn of 2.7×10⁴.

### (Synthesis of Block Copolymer)

While the obtained NMP/DMSP mixed solution of the second polymer compound was being stirred, all of the above-mentioned DMSO solution of the first polymer compound, 610 g of DMSO, and 1790 g of NMP were added to the mixture solution and block copolymerization reaction was carried out at 150° C. for 39 hours.

The obtained reaction solution was dropwise added to a large quantity of 2N hydrochloric acid and immersed for 1 hour. Thereafter, the precipitate produced was separated by filtration and again immersed in 2N hydrochloric acid for 1 hour. The obtained precipitate was separated by filtration and washed with water and then immersed in a large quantity of hot water at 95° C. for 1 hour. After a solid was separated by filtration, the solid was again immersed in a large quantity of hot water at 95° C. for 1 hour. After the solid was Separated by filtration, the solid was dried overnight at 80° C. to obtain a block copolymer.

Membrane production was carried out in the same manner as Example 1.

### [Obtained Block Copolymer Type Polymer Electrolyte]

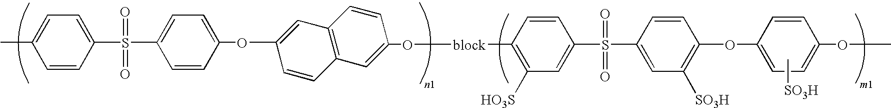

In the formula, n1 and m1 denote the average polymerization degree of the respective blocks of the block copolymer type polymer electrolyte.

### Mn 7.9×10⁴.

Actually measured value of ion exchange capacity: 1.94 meq/g
Membrane production: NMP solution cast method: membrane thickness: 27 μm
Proton conductivity: 2.37×10⁻¹ S/cm
Water absorption ratio: 115%

Being calculated from charging, n1=36.2 and m=10.5.

### [MSA]

The polymer electrolyte membrane comprising the block copolymer type polymer electrolyte obtained in the above-mentioned manner was cut out in a square shape and set on a heating stage and the catalyst ink A was applied to a region of 5.2 cm square in the center part of the main face of the membrane by a spraying method. The distance from the outlet to the membrane was 5 cm and the stage temperature was set at 76° C. After the application, the membrane was left for 3 minutes on the stage to remove the solvent and form a catalyst layer. The polymer electrolyte membrane provided with the catalyst layer on one face in the above-mentioned manner was turned upside down and set on the heating stage and again a catalyst layer was formed using the catalyst ink A also on the other face in the same manner as the former catalyst layer to obtain a membrane-electrode assembly. The platinum amount in the catalyst layers calculated from the weight composition of the catalyst layers and the catalyst layer weight was 0.6 mg/cm² for each face.

### [Cell Assembly for Fuel Cell Evaluation]

A fuel cell was produced using a commercially available JARI standard cell. That is, a carbon cloth as a gas diffusion layer and a separator made of carbon having a groove formed by cutting processing for a gas channel were arranged in both catalyst layers of the membrane-electrode assembly obtained in the above-mentioned manner and current collectors and end plates were successively arranged further outside thereof and the arranged parts were fastened by bolts to assemble a fuel cell with an effective membrane surface area of 25 cm².

### [Fuel Cell Evaluation]

While the obtained fuel cells was kept at 80° C., humidified hydrogen and humidified air were supplied to an anode and a cathode, respectively. At that time, the back-pressure at the gas outlet of the cell was adjusted to be 0.1 MPaG. The humidification of the respective raw material gases was carried out by leading the gases to bubblers and the water temperature of the bubbler for hydrogen was set to be 45° C. and the water temperature of the bubbler for air was set to be 55° C.

Herein, the gas flow rate of hydrogen was set to be 529 mL/min and the gas flow rate of air was set to be 1665 mL/min. The current density at 0.2 V of the cell potential was 1.5 A/cm. The cell potential at 0.5 A/cm of the current density was 0.59 V.

### Comparative Example 3

### Synthesis of Copolymer G

A polymer electrolyte membrane comprising a copolymer G represented by the following formula was obtained in the same manner as Example 3 of Japanese Unexamined Patent Publication No. 10-021943.

Herein, n1 and m1 denote the molar ratio of the respective structural units of the random copolymer type polymer electrolyte.

### [Copolymer G]

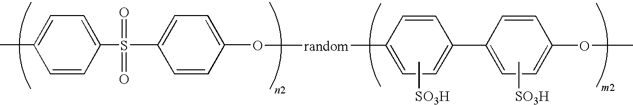

### Mn 4.5×10⁴.

Actually measured value of ion exchange capacity: 1.11 meq/g
Membrane production: DMAc solution cast method: membrane thickness: 20 μm
Proton conductivity: 7.81×10⁻³ S/cm
Water absorption ratio: 41%
m2/(n2+m2)=0.14

### [Production of Catalyst Paste]

A uniform copolymer B solution (concentration of copolymer B: 5% by weight) was produced by mixing 9.5 g of NMP and 0.5 g of the copolymer G. Separately, 0.64 g of platinum-supporting carbon (SA 50 BK, manufactured by N.E. CHEMCAT CORPORATION; platinum support amount 50% by weight) was charged to 11 mL of ethanol and further 1.05 g of the previously prepared copolymer A solution was added to the mixture. After the obtained mixture was treated for 1 hour by ultrasonic treatment, it was stirred by a stirrer for 6 hours to obtain a catalyst ink B.

### [Production of Polymer Electrolyte Membrane]

The polymer electrolyte membrane comprising the block copolymer type polymer electrolyte used in Example 5 was used.

### [MEA]

A carbon cloth to be a gas diffusion layer was cut out in a square shape and set on a heating stage and the catalyst ink B was applied to a region of 5.2 cm square in the center part of the main face of the carbon cloth by a spraying method. The distance from the outlet to the carbon cloth was 5 cm and the stage temperature was set at 76° C. After the application, the cloth was left for 3 minutes on the stage to remove the solvent and form a catalyst layer. Two sheets of a carbon cloth on which the catalyst layer was formed in the above-mentioned manner were produced. The platinum amount in the catalyst layers calculated from the weight composition of the catalyst layers and the catalyst layer weight was 0.6 mg/cm² for each face. Thereafter, to remove NMP remaining in the carbon cloth, the resulting carbon cloth sheets were immersed in 1 N hydrochloric acid and successively washed with water for 1 hour. An electrolyte membrane was sandwiched with these two carbon cloth sheets from which NMP was removed and the product was pressed at 120° C. and 10 kgf/cm² for 15 minutes to complete a membrane-electrode assembly.

### [Cell Assembly for Fuel Cell Evaluation]

A fuel cell was produced using a commercially available JARI standard cell. That is, a separator made of carbon having a groove formed by cutting processing for a gas channel was arranged in both gas diffusion layers of the membrane-electrode assembly obtained in the above-mentioned manner and current collectors and end plates were successively arranged further outside thereof and the arranged parts were fastened by bolts to assemble a fuel cell with an effective membrane surface area of 25 cm².

### [Fuel Cell Evaluation]

While the obtained fuel cells was kept at 80° C., humidified hydrogen and humidified air were supplied to an anode and a cathode, respectively. At that time, the back-pressure at the gas outlet of the cell was adjusted to be 0.1 MPaG. The humidification of the respective raw material gases was carried out by leading the gases to bubblers and the water temperature of the bubbler for hydrogen was set to be 45° C. and the water temperature of the bubbler for air was set to be 55° C.

Herein, the gas flow rate of hydrogen was set to be 529 mL/min and the gas flow rate of air was set to be 1665 mL/min. The current density at 0.2 V of the cell potential was 1.1 A/cm. The cell potential at 0.5 A/cm of the current density was 0.44 V.

The copolymer of the present invention shows excellent capabilities for properties such as water-proofness, membrane formability, and proton conductivity as a polymer electrolyte, particularly a proton conductive membrane of a fuel cell. It is particularly excellent in water-proofness.

Further, when the copolymer is used as a proton conductive membrane for a fuel cell, since it shows high power generation characteristics, the copolymer of the present invention is industrially advantageous as a polymer electrolyte.

1. A copolymer obtained by nucleophilic condensation of a mixture of the following (A) and (C) with a mixture of (B) and (D), or of a mixture of (A), (B), (C) and (D):
(A) a monomer having two leaving groups and further at least one acid group in a molecule;
(B) a monomer having two nucleophilic groups and further at least one acid group in a molecule;
(C) a monomer having two leaving groups and substantially no acid group in a molecule; and
(D) a monomer having two nucleophilic groups and substantially no acid group in a molecule.

2. The copolymer according to claim 1, wherein said (A) is represented by the following formula (1):
X¹—Ar¹Z¹—Ar²ₖX¹ (1)
wherein, k denotes 0, 1, or 2; Ar¹ and Ar² each independently denote a divalent aromatic group; when k is 2, two Ar² groups may be the same or different with each other and these divalent aromatic groups may be substituted with an alkyl group having 1 to 10 carbon atoms which may have a substituent, an alkoxy group having 1 to 10 carbon atoms which may have a substituent, an aryl group having 6 to 10 carbon atoms which may have a substituent, an aryloxy group having 6 to 10 carbon atoms which may have a substituent, a fluoro group, a nitro group, or a benzoyl group; when k is 0, Ar¹ has at least one acid group, and when k is 1 or more, at least one of Ar¹ and Ar² has at least one acid group; XI denotes one of a fluoro group, a chloro group, a nitro group, or a trifluoromethanesulfonyloxy group; two X¹ groups may be the same or different with each other; Z¹ denotes a group selected from the following groups; and when k is 2, two Z¹ groups may be the same or different with each other:

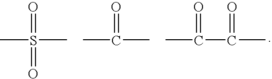

3. The copolymer according to claim 1, wherein said (B) is represented by the following formula (2):
Y¹—Ar³Q¹-Ar⁴ⱼY¹ (2)
wherein, j denotes 0, 1, or 2; Ar³ and Ar⁴ each independently denote a divalent aromatic group; when j is 2, two Ar⁴ groups may be the same or different with each other and these divalent aromatic groups may be substituted with an alkyl group having 1 to 10 carbon atoms which may have a substituent, an alkoxy group having 1 to 10 carbon atoms which may have a substituent, an aryl group having 6 to 10 carbon atoms which may have a substituent, or an aryloxy group having 6 to 10 carbon atoms which may have a substituent; when j is 0, Ar³ has at least one acid group, and when j is 1 or more, at least one of Ar³ and Ar⁴ has at least one acid group; Y¹ denotes a hydroxyl group, a thiol group, or an amino group; two Y1 groups may be the same or different with each other; Q¹ denotes a direct bond or a group selected from the following groups: and when j is 2, two Q¹ groups may be the same or different with each other:

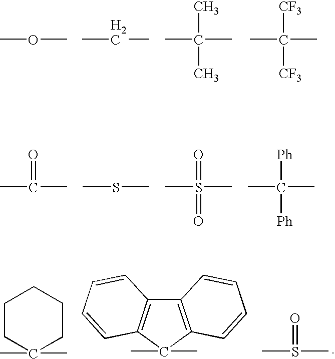

4. The copolymer according to claim 1, wherein said (C) is represented by the following formula (3):
X²—Ar⁵Z²—Ar⁶ₘX² (3)
wherein, m denotes 0, 1, or 2; Ar⁵ and Ar⁶ each independently denote a divalent aromatic group; when m is 2, two Ar⁵ groups may be the same or different with each other and these divalent aromatic groups may be substituted with an alkyl group having 1 to 10 carbon atoms which may have a substituent, an alkoxy group having 1 to 10 carbon atoms which may have a substituent, an aryl group having 6 to 10 carbon atoms which may have a substituent, an aryloxy group having 6 to 10 carbon atoms which may have a substituent, a fluoro group, a nitro group, or a benzoyl group; X² denotes a fluoro group, a chloro group, a nitro group, or a trifluoromethane-sulfonyloxy group; two X2 groups may be the same or different with each other; Z² denotes a group selected from the following groups; and when m is 2, two Z² groups may be the same or different with each other:

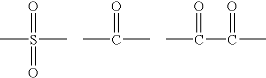

5. The copolymer according to claim 1, wherein said (D) is represented by the following formula (4):
Y²—Ar⁷Q²-Ar⁸ₙY² (4)
wherein, n denotes 0, 1, or 2; Ar⁷ and Ar⁸ each independently denote a divalent aromatic group; when n is 2, two Ar⁸ groups may be the same or different with each other and these divalent aromatic groups may be substituted with an alkyl group having 1 to 10 carbon atoms which may have a substituent, an alkoxy group having 1 to 10 carbon atoms which may have a substituent, an aryl group having 6 to 10 carbon atoms which may have a substituent, or an aryloxy group having 6 to 10 carbon atoms which may have a substituent; Y² denotes a hydroxyl group, a thiol group, or an amino group; two Y² groups may be the same or different with each other; Q² denotes a direct bond or a group selected from the following groups; and when n is 2, two Q² groups may be the same or different with each other:

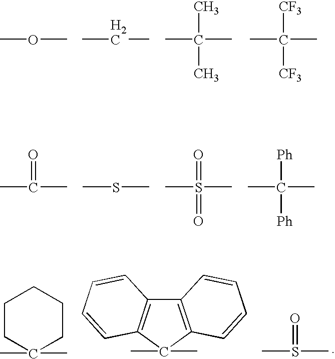

6. The copolymer according to claim 1, wherein the acid group is a strong acid group or a superacid group.

7. The copolymer according to claim 1 having an ion exchange capacity of 0.1 meq/g to 4.0 meq/g.

8. The copolymer according to claim 1, wherein the weight composition ratio of the structural unit having the acid group and the structural unit having substantially no acid group, [structural unit into which the acid group is introduced]:[structural unit into which substantially no acid group is introduced], is 3:97 to 70:30.

9. A polymer electrolyte containing the copolymer according to claim 1.

10. A polymer electrolyte membrane containing the polymer electrolyte according to claim 9.

11. A polymer electrolyte composite membrane comprising the polymer electrolyte according to claim 9 and a porous substrate.

12. A polymer electrolyte composite membrane obtained by impregnating a porous substrate with the polymer electrolyte according to claim 9, and compositing those.

13. A catalyst composition comprising the polymer electrolyte according to claim 9 and a catalyst substance.

14. A fuel cell using the polymer electrolyte membrane according to claim 10.

15. A fuel cell using the polymer electrolyte composite membrane according to claim 11.

16. A fuel cell having a catalyst layer comprising the catalyst composition according to claim 13.

17. A method of producing a copolymer, wherein a mixture of the following (A) and (C) with a mixture of (B) and (D) is condensed, or a mixture of (A), (B), (C) and (D) is condensed:
(A) a monomer having two leaving groups and further at least one acid group in a molecule;
(B) a monomer having two nucleophilic groups and further at least one acid group in a molecule;
(C) a monomer having two leaving groups and substantially no acid group in a molecule: and
(D) a monomer having two nucleophilic groups and substantially no acid group in a molecule.
